(19) United States
(12) Patent Application Publication
(10) Pub. No.: US 2025/0249676 A1
(43) Pub. Date: Aug. 7, 2025

(54) GLASS COVER DISASSEMBLY EQUIPMENT AND GLASS COVER DISASSEMBLY METHOD USING THE SAME

(71) Applicant: INDUSTRIAL TECHNOLOGY RESEARCH INSTITUTE, Hsinchu (TW)

(72) Inventors: Nien-Tsu LEE, Hsinchu City (TW); Chien-Wei LU, Hsinchu City (TW)

(73) Assignee: INDUSTRIAL TECHNOLOGY RESEARCH INSTITUTE, Hsinchu (TW)

(21) Appl. No.: 18/678,926

(22) Filed: May 30, 2024

Related U.S. Application Data
(60) Provisional application No. 63/627,826, filed on Feb. 1, 2024.

(30) Foreign Application Priority Data
Apr. 19, 2024 (TW) 113114751

(51) Int. Cl. B32B 43/00; B09B 3/32; B09B 3/40; B09B 101/15; B09B 101/50

(52) U.S. Cl. CPC B32B 43/006; B09B 3/32; B09B 3/40; B09B 2101/15; B09B 2101/50

(57) ABSTRACT

A glass cover disassembly equipment is configured to disassemble a glass cover of an electronic device from a device body of the electronic device. The electronic device further includes an adhesive layer which bonds the glass cover and the device body. The glass cover disassembly equipment includes a cooling device and a separating device. The cooling device is configured to cool the adhesive layer. The separating device is configured to separate the cooled glass cover and the device body.

This application claims the benefit of U.S. provisional application Ser. No. 63/627,826, filed Feb. 1, 2024, and Taiwan application Serial No. 113114751, filed Apr. 19, 2024, the subject matters of which are incorporated herein by references.

### BACKGROUND OF THE INVENTION

### Field of the Invention

The invention relates in general to a glass cover disassembly equipment and a glass cover disassembly method using the same.

### Description of the Related Art

An electronic device includes a glass cover, a device body and an adhesive layer, wherein the adhesive layer bonds the glass cover and the device body, and the glass cover is recyclable. However, since the entire surface of the glass cover is coated with an adhesive layer that adheres to the device body, it is difficult to be disassembled from the device body. Therefore, it is necessary to propose a technology for disassembling the glass cover from the device to increase the recycling rate of the glass cover, which is one of the goals of industry players in this technical field.

### SUMMARY OF THE INVENTION

According to an embodiment of the present invention, a glass cover disassembly equipment for disassembling a glass cover of an electronic device from a device body of the electronic device is provided. The electronic device further includes an adhesive layer that bonds the glass cover and the body, and the glass cover disassembly equipment includes a cooling device and a separating device. The cooling device is configured to cool the adhesive layer. The separating device is configured to separate the cooled glass cover from the device body.

According to another embodiment of the present invention, a glass cover disassembly method is provided. The glass cover disassembly method includes the following steps: cooling, by a cooling device, an adhesive layer of an electronic device, wherein the adhesive layer bonds a device body of the electronic device and a glass cover of the electronic device; and separating, by a separating device, the cooled glass cover from the device body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a functional block diagram of a glass cover disassembly equipment 100 according to an embodiment of the present invention;

FIG. 2 illustrates a schematic diagram of an electronic device 10 according to an embodiment of the present invention;

FIG. 3 illustrates a top view of the glass cover disassembly equipment 100 in FIG. 1;

FIG. 4A illustrates a schematic diagram of the conveying device 110 and the cooling device 120 in FIG. 1;

FIG. 4B illustrates a top view of a carrier tray 114 in FIG. 4A;

FIG. 4C illustrates a cross-sectional view of the carrier tray 114 in FIG. 4B along a direction 4C-4C′;

FIG. 5 illustrates a schematic diagram of the cooling device 120 in FIG. 1;

FIG. 6 illustrates a schematic diagram of the capturing device 130 and the separating device 140 in FIG. 1;

FIGS. 7A to 7D illustrate schematic diagrams of an operation process of the impactor 141 in FIG. 6;

FIG. 8 illustrates a schematic diagram of a distribution of a plurality of impact points on the electronic device 10 in FIG. 2;

FIG. 9 illustrates a flow chart of the glass cover disassembly method of the glass cover disassembly equipment 100 in FIG. 1; and

FIGS. 10A to 10L illustrate schematic diagrams of processes of the glass cover disassembly equipment 100 disassembling the glass cover 11 from the device body 12 of the electronic device 10.

### DETAILED DESCRIPTION OF THE INVENTION

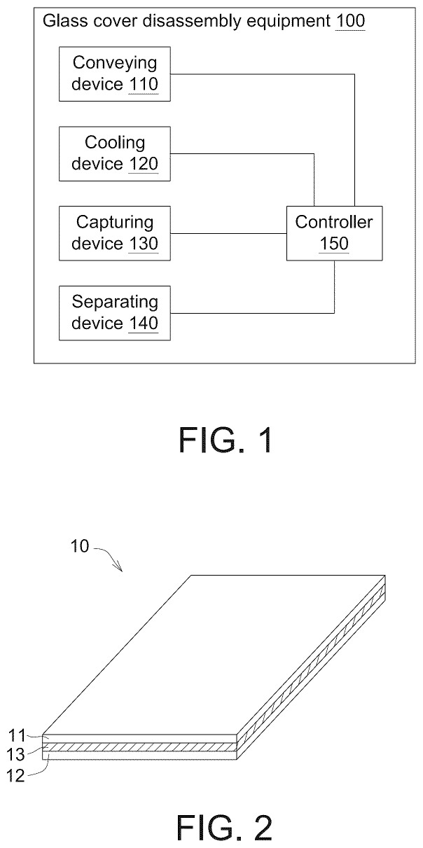

Referring to FIGS. 1 and 2, FIG. 1 illustrates a functional block diagram of a glass cover disassembly equipment 100 according to an embodiment of the present invention, and FIG. 2 illustrates a schematic diagram of an electronic device 10 according to an embodiment of the present invention. The glass cover disassembly equipment 100 is configured to disassemble the glass cover 11 from the device body 12 of the electronic device 10. The electronic device 10 further includes an adhesive layer 13, wherein the adhesive layer 13 adheres the glass cover 11 and the device body 12. The glass cover disassembly equipment 100 includes a conveying device 110, a cooling device 120, a capturing device 130, a separating device 140 and a controller 150. The cooling device 120 is configured to cool the adhesive layer 13. The separating device 140 is configured to separate the glass cover 11 from the device body 12. In an embodiment, the adhesive layer 13 becomes brittle (the viscosity is reduced or lost) after being cooled, making it easier and/or faster for the separating device 140 to separate the glass cover 11 from the device body 12. The separated glass cover 11 may be recycled and reused, thereby increasing the recycling rate of the glass cover 11 of the electronic device 10.

The electronic device 10 is, for example, a smart phone, a tablet computer, and other electronic products including the glass cover. The device body 12 is, for example, a display panel, but the embodiment of the present invention is not limited to this. The adhesive layer 13 is, for example, an optical clear adhesive (OCA). When the temperature of the optical adhesive drops below its glass transition temperature (Tg), its adhesion will be significantly weakened and the optical adhesive will transform into a hard and brittle solid.

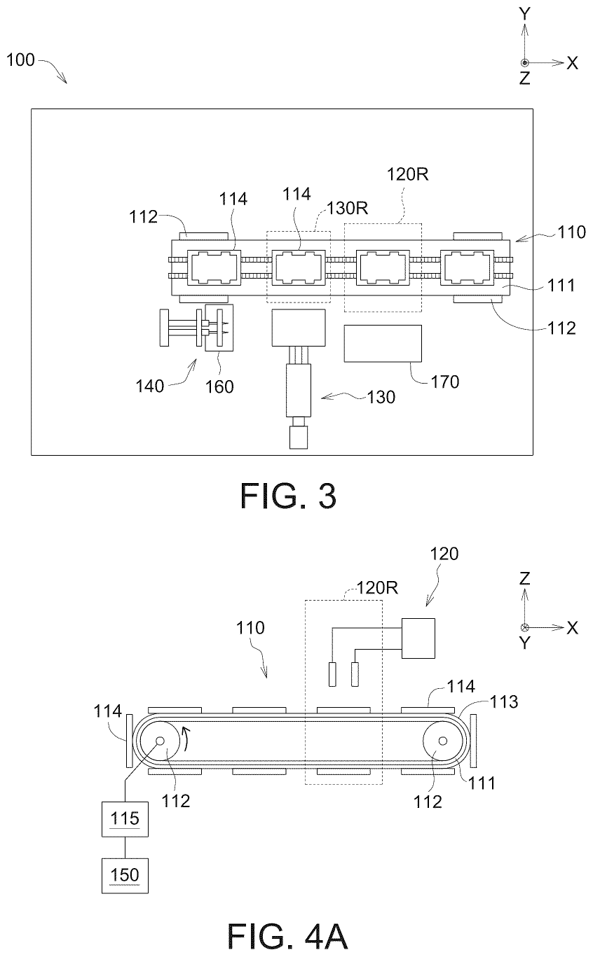

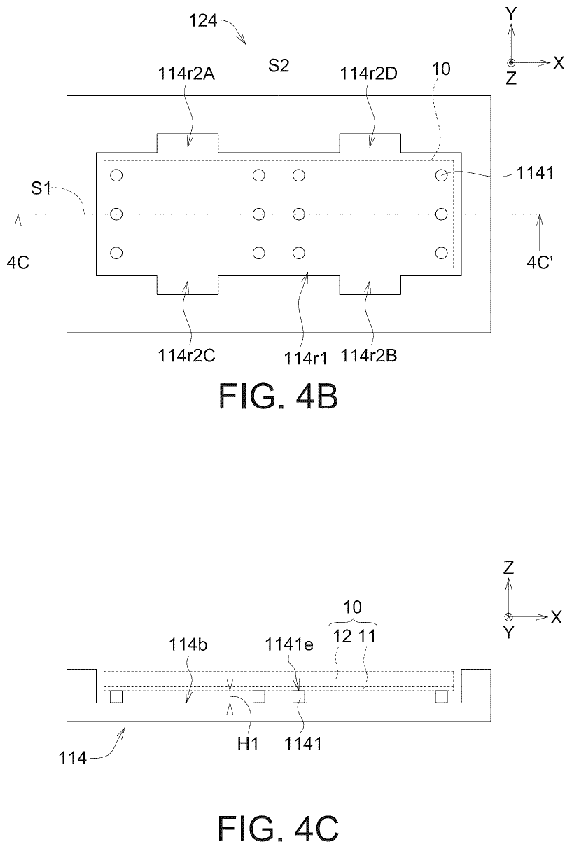

Referring to FIGS. 3 and 4A to 4C, FIG. 3 illustrates a top view of the glass cover disassembly equipment 100 in FIG. 1, and FIG. 4A illustrates a schematic diagram of the conveying device 110 and the cooling device 120 in FIG. 1, FIG. 4B illustrates a top view of a carrier tray 114 in FIG. 4A, and FIG. 4C illustrates a cross-sectional view of the carrier tray 114 in FIG. 4B along a direction 4C-4C′.

As illustrated in FIGS. 3 and 4A, the conveying device 110 may convey the electronic device 10 to the cooling device 120 (at least partially disposed in a cooling zone 120R), so that the cooling device 120 may cool it.

As illustrated in FIG. 4A, the conveying device 110 includes a conveying belt 111, at least one roller 112, at least one fixed belt 113 and a driver 115. At least one carrier tray 114 may be fixed to the conveying belt 111 and configured to carry the electronic device 10. In an embodiment, the carrier tray 114 may not belong to the glass cover disassembly equipment 100; or the carrier tray 114 may be a sub-element of the conveying device 110; or the carrier tray 114 may be a sub-element of the glass cover disassembly equipment 100. The roller 112 is connected to the conveying belt 111 and configured to drive the conveying belt 111 to move. For example, the roller 112 rotates to drive the conveying belt 111 to rotate, and then drives the carrier tray 114 located thereon to move. The fixed belt 113 may be fixed to the conveying belt 111 to move together with the roller 112. In an embodiment, the fixed belt 113 is, for example, a chain, but the embodiment of the present invention is not limited to this. The carrier tray 114 is fixed to the conveying belt 111 and configured to carry the electronic device 10. In the present embodiment, the carrier tray 114 may be fixed to the conveying belt 111 through the fixing belt 113. There is no relative movement among the conveying belt 111, the fixed belt 113 and the carrier tray 114.

As illustrated in FIG. 4B, the carrier tray 114 has a first recess 114r1 and at least one second recess (for example, the second recesses 114r2A, 114r2B, 114r2C and 114r2D) communicated with the first recess 114r1. The first recess 114r1 is configured to accommodate the electronic device 10, wherein one or some of the second recesses are connected to a side of the first recess 114r1, and another one or some of the second recesses may be connected to another side of the first recess 114r1. The cooling fluid (not illustrated) may flow to the first recess 114r1 through the second recess. These second recesses may be disposed adjacent to a plurality of corners of the first recess 114r1. In an embodiment, the second recesses may be symmetrically disposed relative to a first central axis S1 of the first recess 114r1 (for example, parallel to X-axis), and/or the second recesses may be symmetrically disposed relative to a second central axis S2 of the first recess 114r1 (for example, parallel to Y-axis). The symmetrical arrangement of these second recesses allows the cooling fluid flowing to the second recesses to fill the first recesses 114r1 more quickly and evenly.

As illustrated in FIGS. 4B and 4C, the carrier tray 114 further includes at least one protrusion 1141, the protrusion 1141 protrudes relative to a bottom surface 114b of the first recess 114r1 and has a free end surface 1141e, and the free end surface 1141e is configured to abut on the electronic device 10. For example, the free end surface 1141e is configured to abut on the glass cover 11 of the electronic device 10, wherein the glass cover 11 faces the bottom surface 114b. In an embodiment, there is a gap H1 between the bottom surface 114b and the free end surface 1141e to accommodate the cooling fluid (not illustrated in FIG. 4C). In addition, one or some of the protrusions 1141 may be disposed adjacent to a plurality of the corners of the bottom surface 114b, and another one or some of the protrusions 1141 may be disposed adjacent to a middle region of the bottom surface 114b. Due to the positional configuration of these protrusions 1141, the carrier tray 114 may carry a variety of electronic devices 10 of different sizes. In other words, no matter the size of the electronic device 10, as long as the electronic device 10 is placed on the carrier tray 114, it may rest against at least one protrusion 1141. In addition, due to the positional configuration of the protrusions 1141, the electronic device 10 rests against the protrusions 1141 more stably.

As illustrated in FIG. 4A, the driver 115 may be connected to the roller 112 to drive the roller 112 to rotate. In an embodiment, the driver 115 is, for example, a motor. The aforementioned controller 150 may be electrically connected to the driver 115 to control the operation of the driver 115.

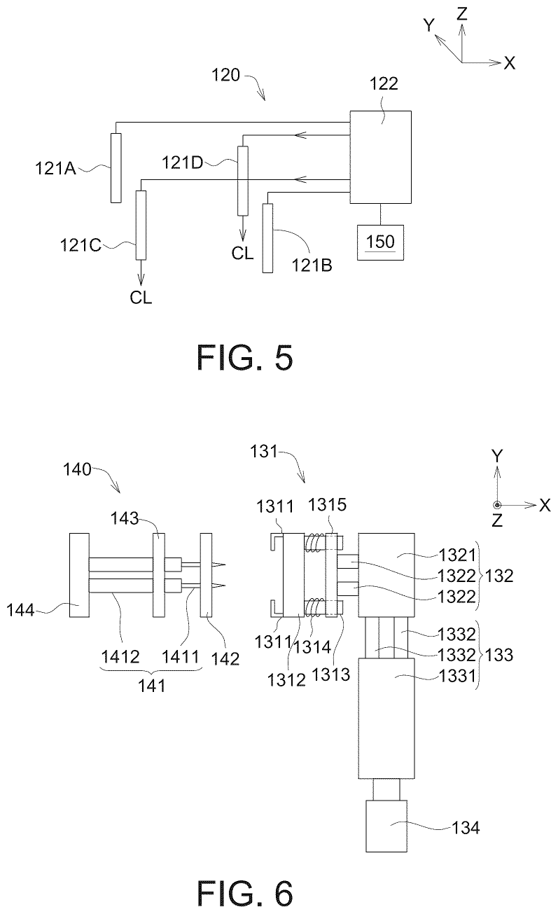

Referring to FIG. 5, FIG. 5 illustrates a schematic diagram of the cooling device 120 in FIG. 1. The cooling device 120 further includes at least one injection pipe (for example, an injection pipe 121A, an injection pipe 121B, an injection pipe 121C and an injection pipe 121D) and a cooling fluid source 122. The injection pipe is connected to the cooling fluid source 122 and is configured to provide the second recesses 114r2A, 114r2B, 114r2C and 114r2D (the second recesses 114r2A, 114r2B, 114r2C and 114r2D are illustrated in FIG. 4B) with the cooling fluid CL. Under the conveying of the conveyor 110, when the carrier tray 114 and the cooling device 120 overlap along Z-axis (for example, the carrier tray 114 is located right below the injection pipe of the cooling device 120), the four injection pipes 121A, 121B, 121C and 121D are corresponding to the four second recesses 114r2A, 114r2B, 114r2C and 114r2D respectively. In an embodiment, the carrier tray 114 and the injection pipe of the cooling device 120 may overlap along Z-axis.

In an embodiment, when the carrier tray 114 and the cooling device 120 overlap along Z-axis, the two injection pipes may provide two second recesses, which are diagonally disposed, with the cooling fluid. For example, at one time point, the injection pipes 121A and 121B respectively provide two diagonally disposed second recesses 114r2A and 114r2B with the cooling fluid. At another time point, the injection pipes 121C and 121D respectively provide two diagonally disposed second recesses 114r2C and 114r2D with the cooling fluid. As a result, the cooling fluid flowing to the second recess may fill the first recess 114r1 more quickly. In an embodiment, the cooling fluid CL is, for example, liquid nitrogen. The low temperature of the liquid nitrogen may cause the adhesive layer 13 of the electronic device 10 to become brittle in an abbreviated time period. However, the cooling fluid CL in the embodiment of the present invention is not limited to the liquid nitrogen. Any fluid that may embrittle the adhesive layer 13 within an abbreviated time (for example, within 5 seconds or within 10 seconds) may be used as the cooling fluid herein.

As illustrated in FIG. 5, the aforementioned controller 150 may be electrically connected to the cooling fluid source 122 to control the cooling fluid source 122 to supply or not to supply the cooling fluid CL to the injection pipe. The cooling fluid source 122 includes, for example, at least one valve (not illustrated), and each valve is connected to the corresponding injection pipe. The controller 150 may control the valve to open or close to control the cooling fluid CL in the cooling fluid source 122 to supply to or not supply to the injection pipe.

Referring to FIG. 6, FIG. 6 illustrates a schematic diagram of the capturing device 130 and the separating device 140 in FIG. 1. The capturing device 130 includes a robot arm 131, a first translation driving unit 132, a second translation driving unit 133 and a rotation unit 134.

As illustrated in FIG. 6, the robot arm 131 is configured to clamp the electronic device 10. For example, the robot arm 131 includes at least two clamping claws 1311, a chuck 1312, a connecting rod 1313, an elastic element 1314 and a connecting plate 1315. The clamping claws 1311 may move toward the +/−Y-axis to clamp or release the electronic device 10. The clamping claw 1311 may be disposed on the chuck 1312. The connecting rod 1313 is connected to the chuck 1312 and passes through the connecting plate 1315. The connecting rod 1313 is moveable relative to the connecting plate 1315 (for example, along +/−X-axis). The elastic element 1314 surrounds the connecting rod 1313 and is located between the chuck 1312 and the connecting plate 1315, allowing the chuck 1312 to move relative to the connecting plate 1315. In an embodiment, when the clamping claws 1311 capture (for example, clamp) the electronic device 10, the elastic element 1314 may provide the chuck 1312 with a pressing force (due to deformation) for clamping the electronic device 10 between the chuck 1312 and the clamping claw 1311, thereby fixing a relative position among the electronic device 10, the chuck 1312 and the clamping claw 1311. When an impact force is applied to the robot arm 131, the elastic element 1314 may reciprocate along X-axis to generate vibration. The elastic element 1314 may increase the stiffness (K value) of the entirety (or system) of the robot arm 131 or the capturing device 130 to increase the system oscillation period. The increase in the oscillation period causes the glass cover 11 of the electronic device 10 to withstand vibration for a longer time, which facilitates the separation of the glass cover 11 from the device body 12.

As illustrated in FIG. 6, the first translation driving unit 132 is connected to the robot arm 131 and is configured to drive the robot arm 131 to approach the electronic device 10 and drive the robot arm 131 to approach the separating device 140. The first translation driving unit 132 includes a first driver 1321 and at least one first movable rod 1322. The first movable rod 1322 connects the first driver 1321 with the connecting plate 1315 of the robot arm 131. The first driver 1321 is configured to drive the first movable rod 1322 to move along +/−X-axis (the first movable rod 1322 stretches out or retracts relative to the first driver 1321) to drive the machine arm 131 to move along +/−X-axis. In an embodiment, the first driver 1321 is, for example, a pressure cylinder, such as a pneumatic cylinder or a hydraulic cylinder.

As illustrated in FIG. 6, the second translation driving unit 133 is connected to the first translation driving unit 132 and is configured to drive the first translation driving unit 132 to be aligned with the separating device 140. In an embodiment, the second translation driving unit 133 includes a second driver 1331 and at least a second movable rod 1332. The second movable rod 1332 connects the second driver 1331 with the first translation driving unit 132. For example, the second movable rod 1332 connects the second driver 1331 and the first driver 1321 of the first translation driving unit 132. The second driver 1331 is configured to drive the second movable rod 1332 to move along +/−Y-axis (the second movable rod 1332 stretches out or retracts relative to the second driver 1331). In an embodiment, the second driver 1331 is, for example, a pressure cylinder, such as a pneumatic cylinder or a hydraulic cylinder.

As illustrated in FIG. 6, the rotation unit 134 is connected to the second translation driving unit 133 and is configured to rotate the second translation driving unit 133 to drive the robot arm 131 to be aligned with the separating device 120.

In summary, when the conveying device 110 conveys the electronic device 10 to a zone 130R corresponding to the capturing device 130, the capturing device 130 may capture the electronic device 10 and move the electronic device 10 to be aligned with the separating device 140 for allowing the separating device 140 to separate the glass cover 11 from the device body 12.

As illustrated in FIG. 6, the separating device 140 includes at least one impactor 141, a first limiting plate 142, a second limiting plate 143 and a third limiting plate 144. The impactor 141 is configured to apply an impact force to the glass cover 11 of the electronic device 10. Each impactor 141 includes an impacting pin 1411 and an impacting unit 1412, wherein a portion of the impacting pin 1411 is disposed in the impacting unit 1412, and another portion of the impacting pin 1411 (for example, the portion with a tip) protrudes relative to the impacting unit 1412. The impacting unit 1412 may provide the impact force to the impacting pin 1411, and the impact force is transferred to the glass cover 11 of the electronic device 10 through the impacting pin 1411 to shatter the glass cover 11.

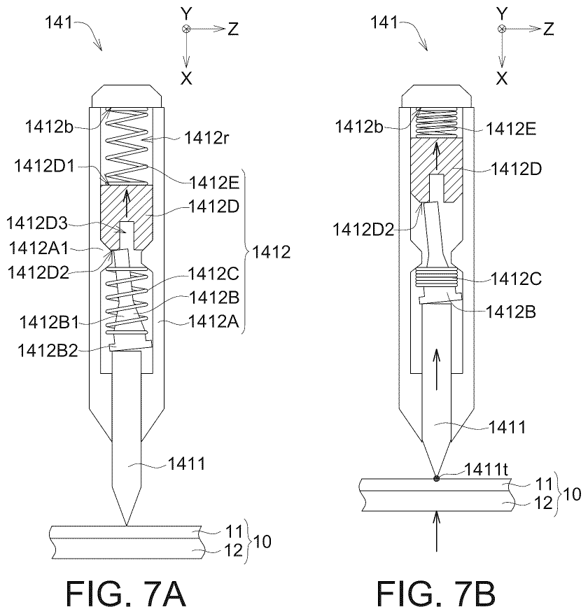

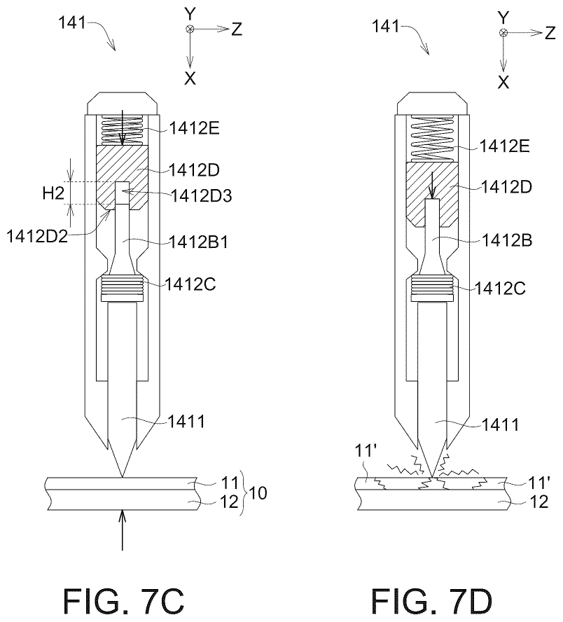

Referring to FIGS. 7A to 7D, FIGS. 7A to 7D illustrate schematic diagrams of an operation process of the impactor 141 in FIG. 6.

As illustrated in FIG. 7A, the impacting unit 1412 of the impactor 141 includes a housing 1412A, a first push block 1412B, a first elastic element 1412C, a second push block 1412D and a second elastic element 1412E. The first push block 1412B, the first elastic element 1412C, the second push block 1412D and the second elastic element 1412E are disposed within a hollow portion 1412r of the housing 1412A. The housing 1412A includes a resisting portion 1412A1 protruding from its inner wall surface and defining a portion of the hollow portion 1412r. The first elastic element 1412C is disposed between a first side of the resisting portion 1412A1 (for example, the side where the resisting portion 1412A1 is close to the impacting pin 1411) and the first push block 1412B. The first push block 1412B includes a body 1412B1 and a flange 1412B2, where the flange 1412B2 is connected to the body 1412B1. The first elastic element 1412C is disposed between the first side of the resisting portion 1412A1 and the flange 1412B2 of the first push block 1412B. The second elastic element 1412E is disposed between a second side of the resisting portion 1412A1 (for example, the side where the resisting portion 1412A1 is away from the impacting pin 1411) and the second push block 1412D. The second push block 1412D has a first end surface 1412D1 and a second end surface 1412D2 opposite to the first end surface 1412D1, and a recess 1412D3, wherein the recess 1412D3 extends from the second end surface 1412D2 toward the first end surface 1412D1. The second elastic element 1412E is disposed between the first end surface 1412D1 of the second push block 1412D and a bottom surface 1412b of the hollow portion 1412r.

As illustrated in FIG. 7A, the first elastic element 1412C and the second elastic element 1412E may be in a free state. In an embodiment, the first elastic element 1412C and the second elastic element 1412E are, for example, springs, such as compression springs.

As illustrated in FIG. 7B, when the impacting pin 1411 of the impactor 141 moves toward the bottom surface 1412b (for example, the electronic device 10 pushes the impacting pin 1411 to move toward the bottom surface 1412b), the impacting pin 1411 pushes the first push block 1412B to move toward the bottom surface 1412b, and at the same time, the first elastic element 1412C deforms to store elastic potential energy. When the impacting pin 1411 of the impactor 141 moves toward the bottom surface 1412b, the first push block 1412B presses the second end surface 1412D2 of the second push block 1412D to push the second push block 1412D to move toward the bottom surface 1412b. At the same time, the elastic element 1412E deforms to store the elastic potential energy.

As illustrated in FIG. 7C, when the second elastic element 1412E is deformed to the extreme position, the body 1412B1 of the first push block 1412B slides into the recess 1412D3 through the second end surface 1412D2 (for example, a curved surface, an arc surface or a leading angle). When the body 1412B1 slides into the recess 1412D3, there is a distance H2 between the bottom surface of the recess 1412D3 and the end surface of the body 1412B1. The distance H2 provides the second push block 1412D with an impact stroke.

As illustrated in FIG. 7D, since the body 1412B1 slides into the recess 1412D3, the second elastic element 1412E releases the elastic potential energy and drives the second push block 1412D to collide with the first push block 1412B for generating the impact force which is transferred to the electronic device 10 through the first push block 1412D and the impacting pin 1411. Since there is the distance H2 between the bottom surface of the recess 1412D3 and the end surface of the body 1412B1, such distance H2 causes the second push block 1412D to hit the first push block 1412B at a certain speed (based on the second elastic element 1412E releases the elastic potential energy). When the impact force is transferred to the electronic device 10, the glass cover 11 of the electronic device 10 may be shattered.

During the process of applying the impact force to the electronic device 10, the first elastic element 1412C and the second elastic element 1412E perform reciprocating motion to generate the vibration. The elastic element may increase the overall stiffness (K value) of the impactor 141 (or system) to increase the system oscillation period. The increase in the oscillation period causes the glass cover 11 of the electronic device 10 to withstand the vibration for a longer time, and it is conducive to the separation of the glass cover 11 and the device body 12 and/or the fragmentation of the glass cover 11. In an embodiment, the electronic device 10 may press against the impactor 141 of the separating device 140 for a time period. As a result, the impact force transferred to the electronic device 10 may last for a time period (for example, seconds), and it causes the vibration to be transferred to the entire glass cover 11 to destroy the entire glass cover 11 as much as possible. As a result, the glass cover fragments remaining on the body 12 are minimized or even eliminated.

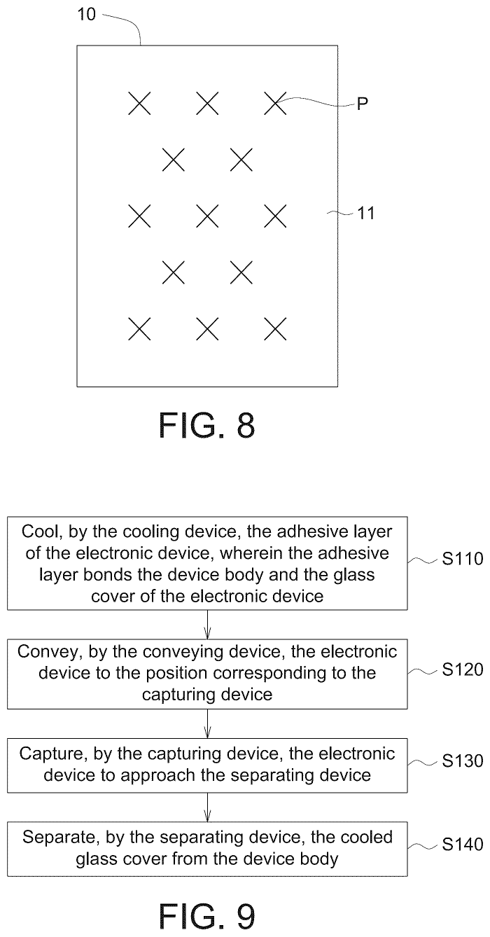

Referring to FIG. 8, FIG. 8 illustrates a schematic diagram of a distribution of a plurality of impact points on the electronic device 10 in FIG. 2. The impact points P represent the position where the impactor 141 impacts the electronic device 10. The plurality of the impact points P may be distributed approximately evenly. A distribution pattern of the impact points P is determined, for example, in the following manner (or effect): the glass cover 11 may be completely shattered and the shattered pieces still retain a certain size. The fragment of a certain size facilitates subsequent storage, transportation and/or processing. As long as the aforementioned effects may be obtained, the embodiments of the present disclosure do not limit the number and/or the positions of the impact points P.

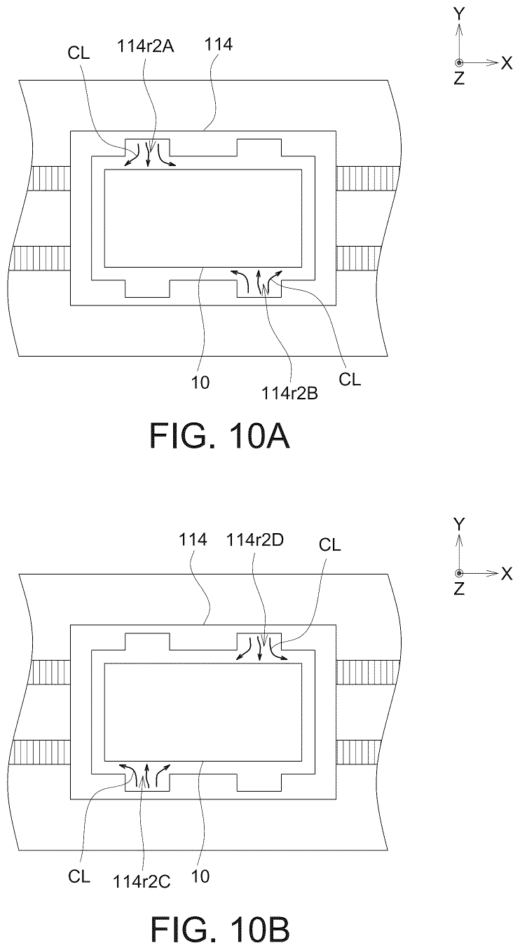

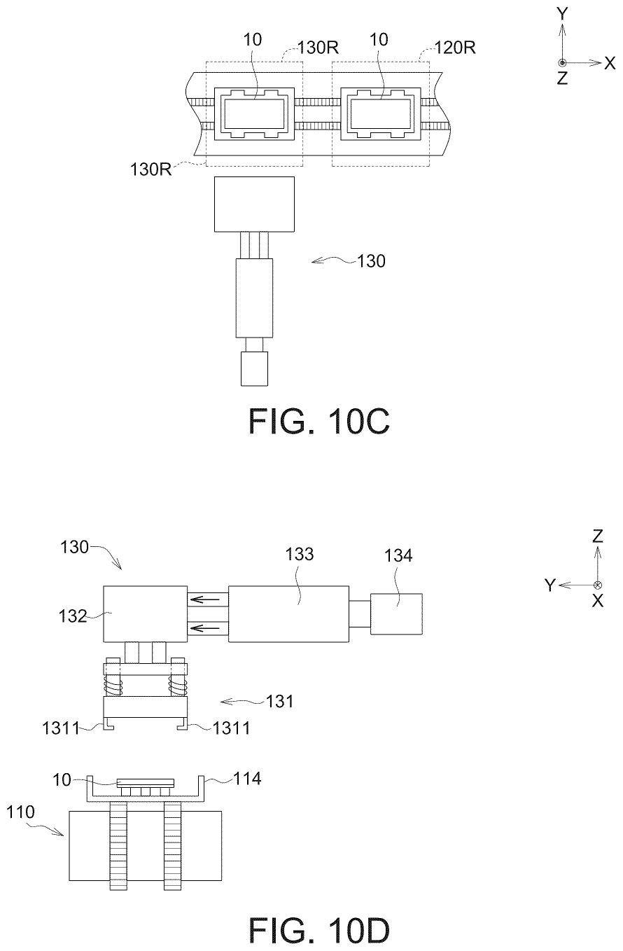

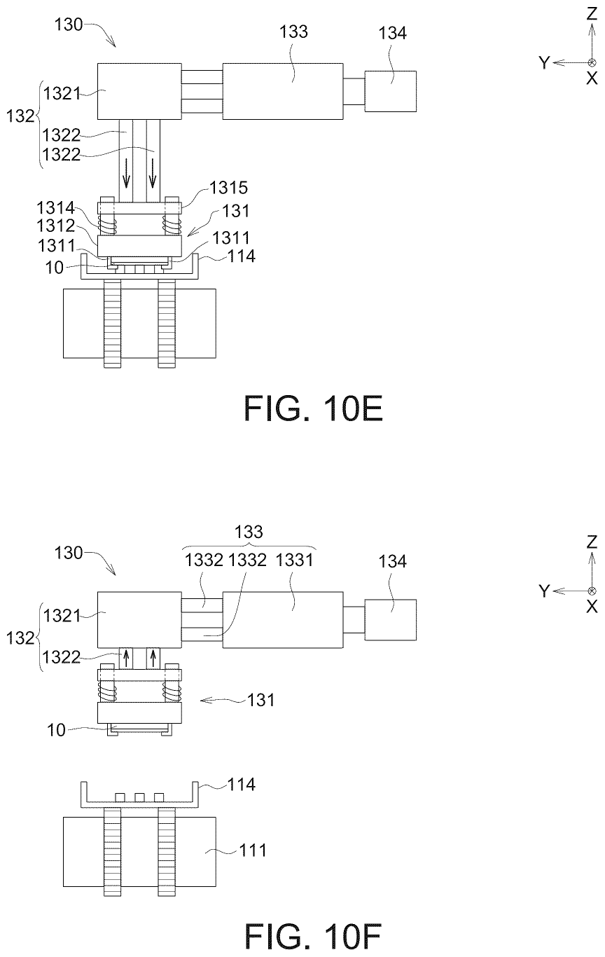

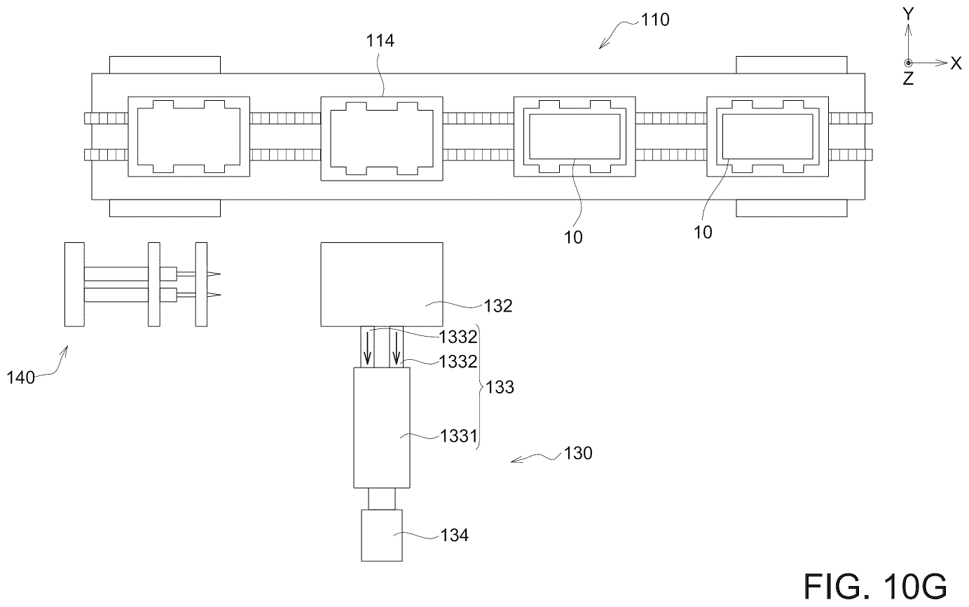

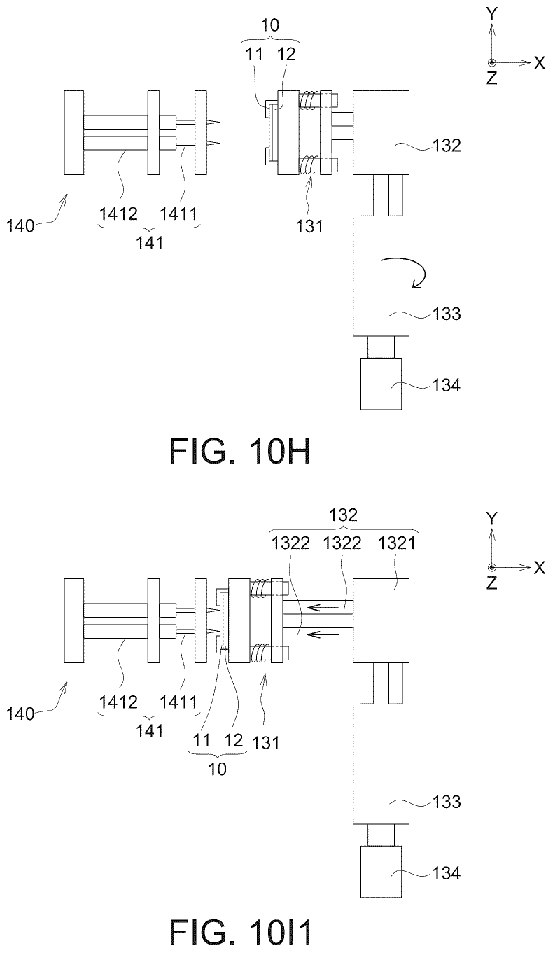

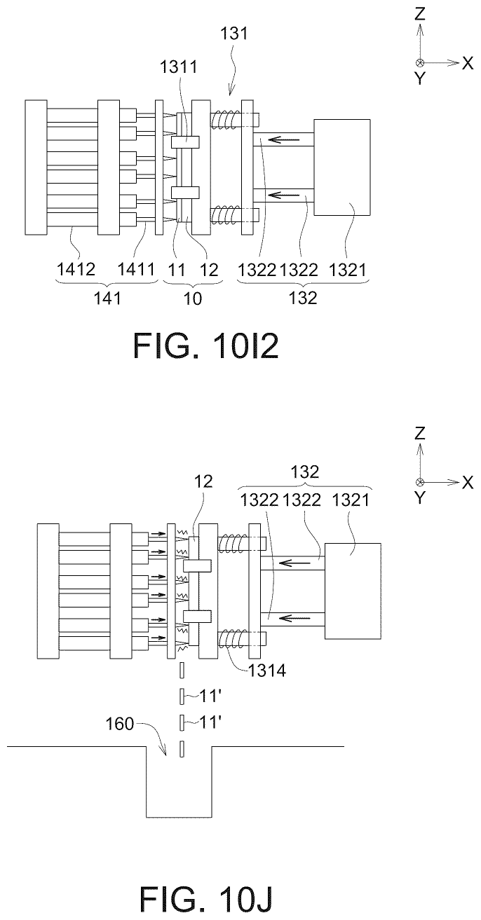

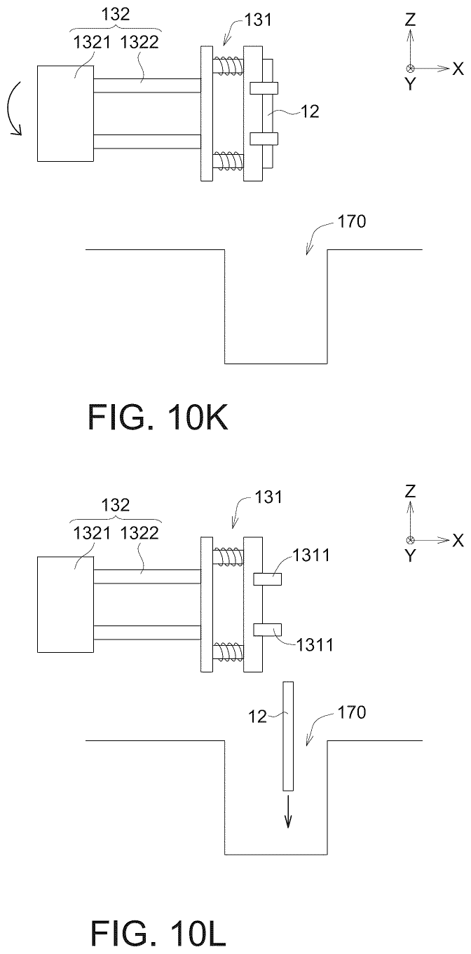

Referring to FIGS. 9 and 10A to 10L, FIG. 9 illustrates a flow chart of the glass cover disassembly method of the glass cover disassembly equipment 100 in FIG. 1, and FIGS. 10A to 10L illustrate schematic diagrams of processes of the glass cover disassembly equipment 100 disassembling the glass cover 11 from the device body 12 of the electronic device 10.

In step S110, as illustrated in FIGS. 10A and 10B, the cooling device 120 cools the adhesive layer 13 of the electronic device 10. For example, when the conveying device 110 conveys the carrier tray 114 to the cooling zone 120R, the injection pipes 121A and 121B in FIG. 5 respectively supply the cooling fluid CL to the second recesses 114r2A and 114r2B for a first time period, as illustrated in FIG. 10A. Then, as illustrated in FIG. 10B, the injection pipes 121C and 121D in FIG. 5 respectively supply the cooling fluid CL to the second recesses 114r2C and 114r2D for a second time period. After the cooling fluid CL flows to the second recesses, the cooling fluid CL flows to the first recess 114r1. The aforementioned first time period and the second time period may be the same or different. The first time period is, for example, several seconds (e.g., 1 second to 10 seconds), and the second time period is, for example, several seconds (e.g., 1 second to 10 seconds).

In the present embodiment, in a cooling procedure, a first injection pipe group (for example, the injection pipes 121A and 121B) and a second injection pipe group (for example, the injection pipes 121C and 121D) may supply the cooling fluid CL to the carrier tray 114 once at two different time points respectively. However, in another embodiment, during the cooling procedure, the first injection pipe group may supply the cooling fluid CL to the carrier tray 114 at least once and/or the second injection pipe group may supply the cooling fluid CL to the carrier tray 114 at least once. As long as the first recess 114r1 may be filled with the cooling fluid CL within a predetermined time, the embodiment of the present invention does not limit the number of times and/or the time duration that the injection pipe group (or the injection pipe) supplies the cooling fluid CL to the carrier tray 114.

After the first recess 114r1 is filled with cooling fluid CL, the cooling fluid CL may be in contact with the glass cover 11 (illustrated in FIG. 2) of the electronic device 10 (illustrated in FIG. 2) to reduce the temperature of the adhesive layer 13 of the electronic device 10 (illustrated in FIG. 2). When the temperature of the adhesive layer 13 drops below its glass transition temperature, its adhesion will be significantly weakened, and the adhesive layer 13 will also transform into a hard and brittle solid.

In step S120, as illustrated in FIG. 10C, after the cooling process is completed, the conveying device 110 continues to convey the electronic device 10 along-X-axis until it corresponds to the capturing device 130 in position, for example, the electronic device 10 is located at the zone 130R. Furthermore, viewed from the perspective of 10C, the electronic device 10 and the capturing device 130 overlap along Y-axis.

In step S130, as illustrated in FIGS. 10D to 1012, the capturing device 130 captures the electronic device 10 to approach the separating device 140.

For example. As illustrated in FIG. 10D, the second driver 1331 of the second translation driving unit 133 drives the second movable rod 1332 to move along +Y-axis for driving the first translation driving unit 132 and the robot arm 131 to synchronously move along +Y-axis until the robot arm 131 overlaps the electronic device 10 along Z-axis (for example, the robot arm 131 is located right above the electronic device 10).

As illustrated in FIG. 10E, the first driver 1321 of the first translation driving unit 132 drives the first movable rod 1322 to move along −Z-axis to drive the robot arm 131 to synchronously move along −Z-axis until the four clamping claws 1311 (due to the perspective, only two in FIG. 10E may be seen) of the robot arm 131 enters the four second recesses (for example, 114r2A, 114r2B, 114r2C and 114r2D) of the carrier tray 114. After the clamping claws 1311 enter the second recess of the carrier tray 114, these clamping claws 1311 clamp the electronic device 10.

Although not illustrated, the robot arm 131 further includes a driving device (for example, a motor, a pneumatic cylinder, or a combination thereof) connected to the clamping claw 1311. The driving device may be disposed in a space between the connecting plate 1315 and the chuck 1312. Before clamping, the driving device may drive the clamping claw 1311 to move relative to the chuck 1312 along −Z-axis and/or Y-axis as illustrated in the figure, so that, in the process of the robot arm 131 descending along the −Z-axis, the clamping claws 1311 will not interfere with the electronic device 10 and may face two sides and a lower surface of the electronic device 10. After the clamping claw 1311 enters the second recess of the carrier tray 114, the driving device may drive the clamping claw 1311 to move relative to the chuck 1312 along +Z-axis and/or Y-axis as illustrated in the figures until the electronic device 10 is clamped. In addition, when the clamping claws 1311 clamp the electronic device 10, the elastic element 1314 may provide the chuck 1312 (due to the deformation of the elastic element 1314) with the pressing force to further stabilize the relative position among the electronic device 10, the chuck 1312 and the clamping claws 1311.

As illustrated in FIG. 10F, after clamping the electronic device 10, the first driver 1321 of the first translation driving unit 132 drives the first movable rod 1322 to move along +Z-axis for driving the robot arm 131 to synchronously move along +Z-axis until the electronic device 10 is separated from the carrier tray 114.

As illustrated in FIG. 10G, the second driver 1331 of the second translation driving unit 133 drives the second movable rod 1332 to move along −Y-axis for driving the first translation driving unit 132 and the robot arm 131 (the robot arm 131 can't be seen in FIG. 10G) to synchronously move along −Y-axis until the second translation driving unit 133 and the separating device 140 overlap along X-axis.

As illustrated in FIG. 10H, the rotation unit 134 drives the second translation driving unit 133 to rotate around +Y-axis to synchronously drive the first translation driving unit 132 and the robot arm 131 to rotate around +Y-axis until the electronic device 10 is aligned with the separating device 140.

As illustrated in FIGS. 1011 and 1012, the first driver 1321 of the first translation driving unit 132 drives the first movable rod 1322 to move along −X-axis for driving the robot arm 131 to synchronously move along +X-axis until the electronic device 10 abuts on (or is in contact with) the impacting pin 1411 of the impactor 141 of the separating device 140. At this time, the state of the impactor 141 is as illustrated in FIG. 7A.

In step S140, the separating device 140 may separate the cooled glass cover 11 from the device body 12. Furthermore, when the electronic device 10 presses against the impacting pin 1411 of the impactor 141 of the separating device 140, the first driver 1321 of the first translational drive unit 132 may continue to drive the first movable rod 1322 to move along −X-axis, so that the second elastic element 1412E of the impactor 141 deforms, as illustrated in FIG. 7B. When the first driver 1321 of the first translation driving unit 132 continues to drive the first movable rod 1322 to move along −X-axis, the body 1412B1 of the first push block 1412B of the impactor 141 slides into the recess 1412D3 through the second end surface 1412D2, as illustrated in FIG. 7C.

As illustrated in FIG. 10J, the second elastic element 1412E as illustrated in FIG. 7D releases the elastic potential energy and drives the second push block 1412D to collide with the first push block 1412B to generate the impact force to be transferred to the electronic device 10 through the first push block 1412B and the impacting pin 1411. When the impact force is transferred to the electronic device 10, the glass cover 12 of the electronic device 10 may be shattered. The shattered glass cover 11′ falls downward to a glass collection zone 160. The glass collection zone 160 is located right below the separating device 140 and configured to collect the separated glass cover 11′. Because the first elastic element 1412C and the second elastic element 1412E (as illustrated in FIG. 7A) of the impactor 141 and the elastic element 1314 (shown in FIG. 6) of the robot arm 131 may increase the stiffness (K value) of the system, it may increase the system oscillation period to cause the glass cover 11 of the electronic device 10 to withstand vibration for a longer time period, and it is conducive to the separation of the glass cover 11 and the device body 12 and/or the fragmentation of the glass cover 11. In an embodiment, when the glass cover 12 is detached from the device body 12, the elastic element 1314 may continue to provide the impact force to the clamp 1312, so that the device body 12 is still clamped between the chuck 1312 and the clamping claw 1311.

In an embodiment, the glass collection zone 160 is, for example, an opening or a recess disposed on a base of the glass cover disassembly equipment 100. The shattered glass covers 11′ falling into the glass collection zone 160 may be conveyed to the outside of the glass cover disassembly equipment 100 through a conveying belt (not illustrated) for recycling.

As illustrated in FIG. 10K, the rotation unit 134 drives the second translation driving unit 133 to rotate around −Y-axis to synchronously drive the first translation driving unit 132 and the robot arm 131 to rotate around −Y-axis until the electronic device 10 and a body collection zone 170 overlap along Z-axis (for example, the electronic device 10 is located right above the body collection zone 170).

As illustrated in FIG. 10L, the clamping claw 1311 of the robot arm 131 releases the electronic device 10, so that the electronic device 10 to fall. The falling electronic device 10 may fall into the body collection zone 170. The body collection zone 170 is, for example, an opening or a recess disposed on the base of the glass cover disassembly equipment 100. The device body 12 dropped into the body collection zone 170 may be conveyed to the outside of the glass cover disassembly equipment 100 through a conveying belt (not illustrated) for recycling or scrapping.

In addition, the robot arm 131, the first translation driving unit 132, the second translation driving unit 133 and the rotation unit 134 of the capturing device 130 may be controlled by the controller 150 to execute the process of capturing the electronic device 10.

In summary, embodiments of the present invention propose a glass cover disassembly equipment and a disassembly method for a glass cover. After the electronic device is placed in the glass cover disassembly equipment (for example, on a carrier tray), the glass cover and the device body of electronic device is automatically disassembled throughout the process. In an embodiment, since the glass cover disassembly equipment and the disassembly method for the glass cover in the embodiment of the present invention use a robot arm to clamp (or grip) the electronic device, it may be applied to the electronic device with a curved-shape or a flexible electronic device.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A glass cover disassembly equipment for disassembling a glass cover of an electronic device from a device body of the electronic device, wherein the electronic device further comprises an adhesive layer that bonds the glass cover and the body, and the glass cover disassembly equipment comprises:
a cooling device configured to cool the adhesive layer; and
a separating device configured to separate the cooled glass cover from the device body.

2. The glass cover disassembly equipment according to claim 1, wherein the cooling device is further configured to:
supply a cooling fluid to the glass cover for cooling the adhesive layer.

3. The glass cover disassembly equipment according to claim 1, further comprising:
a conveying device configured to convey the electronic device to a position corresponding to the cooling device.

4. The glass cover disassembly equipment according to claim 3, wherein the conveying device comprises:
a conveying belt; and
a roller connected to the conveying belt and configured to drive the conveying belt to move;
wherein a carrier tray is fixed to the conveying belt and configured to carry the electronic device.

5. The glass cover disassembly equipment according to claim 3, further comprising:
a carrier tray having a first recess and at least one second recess connected with the first recess, wherein the first recess is configured to accommodate the electronic device, and the at least one second recess is connected to a side of the first recess.

6. The glass cover disassembly equipment according to claim 5, wherein the carrier tray further comprises:
a protrusion protruding relative to a bottom surface of the first recess and having a free end surface, and the free end surface abuts on the electronic device.

7. The glass cover disassembly equipment according to claim 5, wherein the cooling device further comprises an injection pipe, the injection pipe is configured to supply a cooling fluid to the at least one second recess.

8. The glass cover disassembly equipment according to claim 5, further comprising:
a capturing device configured to capture the electronic device through the second recess.

9. The glass cover disassembly equipment according to claim 1, further comprising:
a capturing device configured to:
capture the electronic device; and
drive the electronic device to approach the separating device;
wherein the separating device is further configured to:
impact the glass cover when the electronic device presses against the separating device.

10. The glass cover disassembly equipment according to claim 9, wherein the capturing device is further configured to:
press the electronic device against the separating device for a time period when the separating device impacts the glass cover.

11. The glass cover disassembly equipment according to claim 9, wherein the separating device further comprises:
an impactor configured to apply an impact force to the glass cover of the electronic device.

12. The glass cover disassembly equipment according to claim 11, wherein the impactor further comprises:
an impact unit; and
an impacting pin, wherein a portion of the impacting pin is disposed within the impacting unit, and another portion of the impacting pin protrudes from the impact unit;
wherein the impact unit is configured to apply the impact force to the impacting pin.

13. The glass cover disassembly equipment according to claim 9, wherein the capturing device further comprises:
a robotic arm configured to:
clamp the electronic device;
a first translation driving unit connected to the robot arm and configured to:
drive the robotic arm to approach the electronic device; and
drive the robot arm to approach the separating device;
a second translation driving unit connected to the first translation driving unit and configured to:
drive the first translation driving unit to be aligned with the separating device;
a rotation unit connected to the second translation driving unit and configured to:
rotate the second translation driving unit to align the robot arm with the separating device.

14. The glass cover disassembly equipment according to claim 1 further comprising:
a glass collection zone located below the separating device and configured to collect the separated glass cover.

15. A glass cover disassembly method, comprising:
cooling, by a cooling device, an adhesive layer of an electronic device, wherein the adhesive layer bonds a device body of the electronic device and a glass cover of the electronic device; and
separating, by a separating device, the cooled glass cover from the device body.

16. The glass cover disassembly method according to claim 15, further comprising:
supplying, by the cooling device, a cooling fluid to the glass cover for cooling the adhesive layer.

17. The glass cover disassembly method according to claim 15, further comprising:
conveying, by a conveying device, the electronic device to a position corresponding to the cooling device.

18. The glass cover disassembly method according to claim 15, further comprising:
capturing, by a capturing device, the electronic device and driving the electronic device to approach the separating device; and
impacting, by the separating device, the glass cover when the electronic device presses against the separating device.

19. The glass cover disassembly method according to claim 18, further comprising:
pressing, by the capturing device, the electronic device against the separating device for a time period when the separating device impacts the glass cover.

20. The glass cover disassembly method according to claim 19, wherein the capturing device comprises a robot arm, a first translation driving unit, a second translation driving unit and a rotation unit; the glass cover disassembly method further comprising:
driving, by the first translation driving unit, the robot arm to approach the electronic device;
clamping, by the robot arm, the electronic device;
driving, by the second translation driving unit, the first translation driving unit to move to be aligned with the separating device; and
rotating, the rotation unit, the robot arm to be aligned with the separating device.
